(19) United States
(12) Patent Application Publication
(10) Pub. No.: US 2015/0364222 A1
(43) Pub. Date: Dec. 17, 2015

(54) NUCLEAR REACTOR SUPPORT AND SEISMIC RESTRAINT

(71) Applicant: BWXT mPower, Inc., Charlotte, NC (US)

(72) Inventors: James B. INMAN, Forest, VA (US); Lewis C. HARTLESS, Madison Heights, VA (US); Michael J. EDWARDS, Forest, VA (US)

(21) Appl. No.: 14/301,789

(22) Filed: Jun. 11, 2014

(51) Int. Cl. G21C 5/10

(52) U.S. Cl. CPC G21C 5/10

(57) ABSTRACT

A nuclear reactor is supported by a primary support anchored to a civil structure and defining a reactor support plane located below the center of gravity of the nuclear reactor. A lateral seismic support engages the nuclear reactor below the reactor support plane to prevent lateral motion of the nuclear reactor. In one approach a flange, protrusion, or ledge of the reactor pressure vessel rests on a support engagement surface, a seismic rotational restraint assembly prevents the nuclear reactor from rotating during a seismic event, and a liftoff prevention assembly prevents vertical liftoff of the flange, protrusion, or ledge of the reactor pressure vessel from the support engagement surface. The lateral seismic support may comprise a pin connected with the bottom of the reactor pressure vessel engaging a pin socket connected with or formed in a floor of the civil structure of the radiological containment containing the nuclear reactor.

### BACKGROUND

The following pertains to the nuclear reactor arts, nuclear power arts, nuclear reactor safety arts, and related arts.

Existing nuclear power plants are typically light water thermal nuclear reactors of the boiling water reactor (BWR) or pressurized water reactor (PWR) types. In such a reactor, a nuclear reactor core comprising fissile material (typically a uranium compound such as UO₂ enriched in fissile ²³⁵U) is immersed disposed in coolant (purified water) contained at an operational pressure and temperature in a reactor pressure vessel. A nuclear chain reaction involving fission of the fissile ²³⁵U generates heat in the nuclear reactor core which is transferred to the coolant. In a BWR design, the heat directly converts coolant to steam in the reactor pressure vessel and is output via large-diameter piping to a turbine to generate electricity. The condensed coolant from the turbine is fed back into the BWR pressure vessel via additional large-diameter piping. In a PWR design, the primary coolant remains in a liquid state (e.g. subcooled) and is piped via large-diameter piping to an external steam generator where heat from the (primary) reactor coolant converts (separate secondary) coolant to steam that in turn drives the turbine. The primary coolant from the steam generator is fed back into the PWR reactor via additional large-diameter piping.

In such designs, the reactor pressure vessel is relatively compact. It contains the reactor core and associated internals such as control rods, and (in the case of a BWR) the steam separator/dryer hardware, along with attached ancillary equipment such as control rod drive systems and valves. The nuclear reactor core is typically the heaviest component and it is located in the lower portion of the reactor pressure vessel so as to reduce likelihood of the core being uncovered in the event of a loss of coolant accident (LOCA). The large-diameter piping connecting the reactor pressure vessel with the coolant loop to the turbine (for a BWR) or steam generator (for a PWR) also provides structural support for the compact reactor pressure vessel.

### BRIEF SUMMARY

In some embodiments described herein as illustrative examples, a nuclear island comprises: a nuclear reactor including a nuclear reactor core comprising fissile material immersed in a reactor pressure vessel; a primary support by which the nuclear reactor is supported, the primary support anchored to a civil structure of a radiological containment containing the nuclear reactor and defining a reactor support plane located above the bottom of the nuclear reactor and below the center of gravity of the nuclear reactor; and a lateral seismic support engaging the nuclear reactor at a plane or point located below the reactor support plane, the lateral seismic support configured to prevent lateral motion of the nuclear reactor. The primary support may include a support engagement surface anchored to the civil structure of the radiological containment containing the nuclear reactor, wherein a flange, protrusion, or ledge of the reactor pressure vessel rests on the support engagement surface, the flange, protrusion, or ledge being located above the bottom of the nuclear reactor and below the center of gravity of the nuclear reactor. The primary support may further comprise a seismic rotational restraint assembly configured to prevent the nuclear reactor from rotating during a seismic event, such as a plurality of lugs disposed on the support engagement surface and lug cutouts defined in the flange, protrusion, or ledge of the reactor pressure vessel, with the lugs mated into the lug cutouts. The primary support may further comprise a liftoff prevention assembly configured to prevent vertical liftoff of the flange, protrusion, or ledge of the reactor pressure vessel from the support engagement surface on which the flange, protrusion, or ledge rests. The radiological containment containing the nuclear reactor may include a reactor cavity inside of which is disposed a lower portion of the nuclear reactor including the nuclear reactor core, and in such embodiments the support engagement surface may be anchored to the top of the reactor cavity.

In reactor island embodiments as set forth in the immediately preceding paragraph, the lateral seismic support may comprise a pin connected with one of (i) the bottom of the reactor pressure vessel and (ii) a floor of the civil structure of the radiological containment containing the nuclear reactor, and a pin socket comprising an opening configured to receive the pin that is connected with or formed in the other of (i) the bottom of the reactor pressure vessel and (ii) a floor of the civil structure of the radiological containment containing the nuclear reactor. In alternative embodiments, the lateral seismic support may comprise three restraints engaging the nuclear reactor at said plane located below the reactor support plane, the three restraints engaging the nuclear reactor at point spaced apart by 120° intervals around the nuclear reactor.

In embodiments of the immediately preceding paragraph in which a pin is connected with the bottom of the reactor pressure vessel and a pin socket is connected with or formed in the floor of the civil structure of the radiological containment containing the nuclear reactor, the lateral seismic support may further include a support base connected to the pin socket and disposed on the floor of the civil structure of the radiological containment containing the nuclear reactor.

In some further embodiments described herein as illustrative examples, a reactor pressure vessel includes a cylindrical main body, an upper vessel head closing the top of the cylindrical main body, and a lower vessel head closing the bottom of the cylindrical main body. A pin is connected to the bottom of the lower vessel head. The pin may be a circular cylindrical pin, and in such embodiments the circular cylindrical pin preferably has a cylinder axis that is coaxial with a cylinder axis of the cylindrical main body of the reactor pressure vessel. In some embodiments the pin and the lower vessel head comprise a single forging.

In some embodiments described herein as illustrative examples, a nuclear reactor comprises the reactor pressure vessel of the immediately preceding paragraph, a nuclear reactor core comprising fissile material disposed in the reactor pressure vessel, and the pin described in the immediately preceding paragraph connected to the bottom of the lower vessel head. A radiological containment may be further provided that contains the nuclear reactor, and a pin socket may be disposed on or in a floor of the radiological containment underneath the nuclear reactor with the pin mated into the pin socket. Such embodiments may further include a support base connected to the pin socket and disposed on the floor of the radiological containment.

In some embodiments described herein as illustrative examples, a method operates in conjunction with a nuclear reactor that includes a nuclear reactor core comprising fissile material disposed in a reactor pressure vessel and further operates in conjunction with a civil structure of a radiological containment that contains the nuclear reactor. The method comprises: suspending the nuclear reactor at a reactor support plane passing through the nuclear reactor wherein the reactor support plane is below a center of gravity of the nuclear reactor; and restraining the nuclear reactor against lateral motion at a plane or point located below the reactor support plane. The nuclear reactor may be so restrained at point at the bottom of a lower vessel head of the nuclear reactor. The suspending operation may include resting a flange, protrusion, or ledge of the reactor pressure vessel located at the reactor support plane on a support engagement surface. In such embodiments the method may further include restraining the flange, protrusion, or ledge of the reactor pressure vessel from lifting off of the support engagement surface, and/or restraining the flange, protrusion, or ledge of the reactor pressure vessel from rotation using a seismic rotational restraint assembly disposed with the support engagement surface.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention. This disclosure includes the following drawings.

FIG. 1 diagrammatically shows a perspective view of an illustrative nuclear reactor island in partial cutaway to reveal internal components.

FIG. 2 diagrammatically shows a perspective view of the reactor cavity of FIG. 1 in partial cutaway along with the three support engagement surfaces built into the top of the reactor cavity.

FIG. 3 diagrammatically shows a perspective view focusing on the lower vessel flange of the flange coupling of FIG. 1 and its engagement with the three support engagement surfaces built into the top of the reactor cavity. FIG. 3 shows the lower vessel flange raised slightly above its installed position in which it rests on the three support engagement surfaces.

FIG. 4 diagrammatically shows a perspective view of a lug on one of the support engagement surfaces shown in FIG. 3, engaged with a lug cutout located at the bottom outer region of the lower vessel flange, and further showing installation of a shim for trimming a lateral gap in the lug/cutout engagement.

FIG. 5 diagrammatically shows a perspective view of a lug on one of the support engagement surfaces shown in FIG. 3, engaged with a lug cutout located at the bottom outer region of the lower vessel flange, and further showing a locking block being inserted into a lug slot of the lug.

FIG. 6 diagrammatically shows the perspective view of FIG. 5 with the locking block inserted into the lug slot and extending laterally into the notches of the lug cutout so as to tie the lower vessel flange to the support engagement surface via the lug. The edge of a seal plate is also shown in phantom.

FIG. 7 diagrammatically shows a perspective view of the bottom seismic support including a pin connected to the bottom of the reactor pressure vessel and extending downward into an opening in a support base located at the bottom of the reactor cavity.

FIG. 8 diagrammatically shows a perspective view of the support base of FIG. 7, along with abutment elements in phantom for laterally anchoring the support base on the floor of the reactor cavity.

FIGS. 9-11 diagrammatically show perspective views of alternative embodiments of the bottom seismic support.

### DETAILED DESCRIPTION OF THE PREFERRED EMBODIMENTS

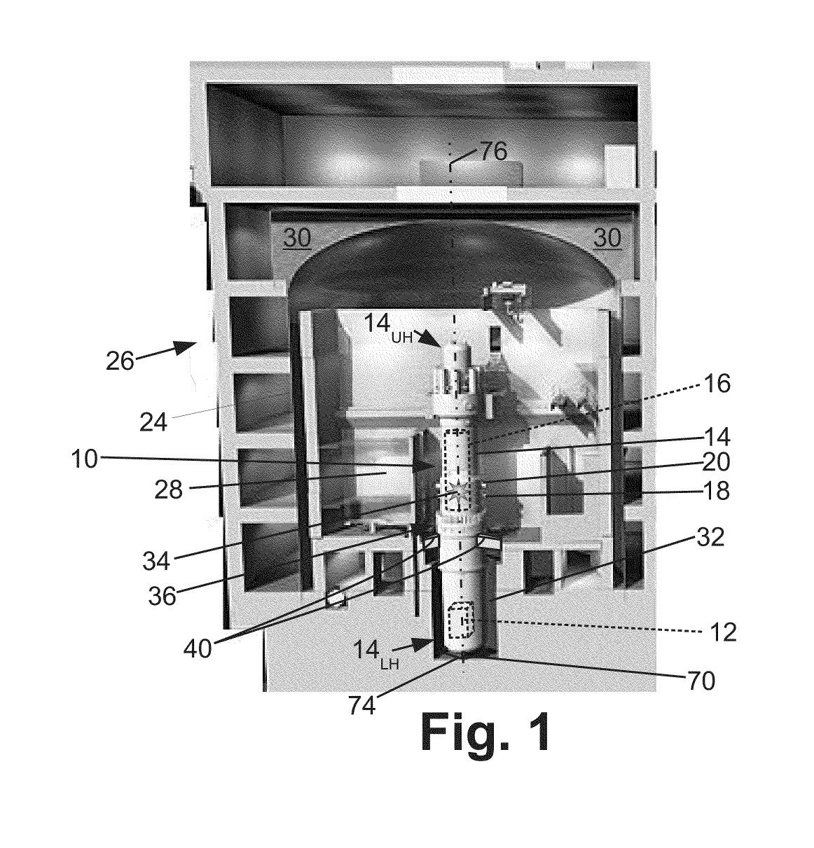

With reference to FIG. 1, an illustrative nuclear reactor island includes a nuclear reactor 10 comprising a nuclear reactor core 12 disposed in a reactor pressure vessel 14. It is to be understood that the reactor pressure vessel 14, which is typically a steel or other metal vessel, is opaque such that the nuclear reactor core 12 is occluded by the reactor pressure vessel 14; accordingly, FIG. 1 shows the reactor core 12 diagrammatically in phantom, i.e. using dashed lines, to indicate it is actually hidden from view being disposed inside the reactor pressure vessel 14. Illustrative reactor pressure vessel 14 is of a typical design in which the reactor pressure vessel comprises a cylindrical main body (optionally with some deviation from a perfect mathematical cylindrical shape, for example to accommodate flanges or other vessel penetrations, small increases or decreases in cylinder diameter along the length of the cylinder, or so forth) with its cylinder axis oriented vertically, and further includes an upper vessel head 14_{UH} closing the top of the cylindrical main body and a lower vessel head 14_{LH} closing the bottom of the cylindrical main body. In such a design, the nuclear reactor core 12 is typically disposed near the bottom of the pressure vessel, that is, closer to the lower vessel head 14_{LH} than to the upper vessel head 14_{UH}.

The illustrative nuclear reactor 10 is of the pressurized water reactor (PWR) variety, but differs from a conventional PWR in that the nuclear reactor 10 further includes an internal steam generator 16 disposed inside the reactor pressure vessel 14. (As with the core 12, the steam generator 16 is occluded from view by the pressure vessel 14 and according is drawn in phantom in FIG. 1). Such a PWR design in which the steam generator is located internally inside the pressure vessel is known in the art as an “integral PWR”. During operation of the nuclear reactor 10, the reactor pressure vessel 14 contains coolant, and the nuclear reactor core 12 includes a fissile material. In the illustrative examples, the nuclear reactor 10 is a light water reactor employing a uranium composition such as uranium oxide (UO₂) enriched in the fissile ²³⁵U isotope, and the coolant is purified water. However, other reactors are contemplated, such as a sodium-cooled nuclear reactor. During reactor operation, the nuclear reactor core 12 supports a nuclear fission chain reaction involving the fissile material (e.g. ²³⁵U), and the nuclear fission chain reaction generates heat in the core 12 that in turn heats the coolant in the reactor pressure vessel 14. The coolant serves as a heat transfer medium to transfer heat from the nuclear reactor core 12 to the internal steam generator 16. Feedwater (secondary coolant) flows into the steam generator 16 via a feedwater inlet vessel penetration 18, and steam (that is, secondary coolant converted to steam by heat from the primary coolant) exits the nuclear reactor 10 via a steam outlet vessel penetration 20. The piping connecting with the vessel penetrations 18, 20 is not illustrated, but is typically of relatively small diameter as compared with the piping of a primary coolant loop of a conventional PWR or of a BWR.

The nuclear reactor 10 is disposed inside a radiological containment 24, which is typically a steel or steel-reinforced concrete structure designed to contain any radiological release from the nuclear reactor 10, for example in the event of a loss of coolant accident (LOCA). In the illustrative nuclear island of FIG. 1, the radiological containment 24 is in turn located inside a reactor service building 26. Additional components may be located inside the radiological containment 24, such as an illustrative refueling water storage tank (RWST) 28. The illustrative nuclear island of FIG. 1 employs an ultimate heat sink (UHS) in the form of passive containment cooling tanks 30 located on a top dome of the radiological containment 24, but other UHS structures are contemplated, such as a cooling tower.

The floor of the radiological containment 24 includes a reactor cavity 32 inside of which is disposed the lower portion of the nuclear reactor 10 including the nuclear reactor core 12 and the lower portion of the reactor pressure vessel 14 which contains the core 12. However, bottom-supporting the nuclear reactor 10 in this position raises certain difficulties. Unlike a conventional PWR or BWR design, the nuclear reactor of illustrative FIG. 1 has a relatively high center-of-gravity 34 due to the presence of additional components, such as the steam generator 16, in the upper portion of the pressure vessel 14. Additionally, the integral PWR 10 does not have connected large-diameter piping for an external primary coolant loop, and hence does not benefit from the structural support provided by such large-diameter pipe connections. Another concern with bottom-supporting the nuclear reactor 10 in the reactor cavity 32 is that in the event of a LOCA or other event leading to the core 12 heating beyond its operational design limits, the bottom support may be compromised.

An alternative approach (not illustrated) for addressing these issues is to employ a top-supported configuration, e.g. suspending the nuclear reactor from above. However, a top-supported configuration has its own disadvantages. It complicates reactor refueling, because in the refueling process an upper head or other upper portion of the reactor pressure vessel is usually removed and fuel assemblies are unloaded and loaded from above via the open upper end. A top-supported configuration can also be susceptible to lateral movement of the nuclear reactor during a seismic event.

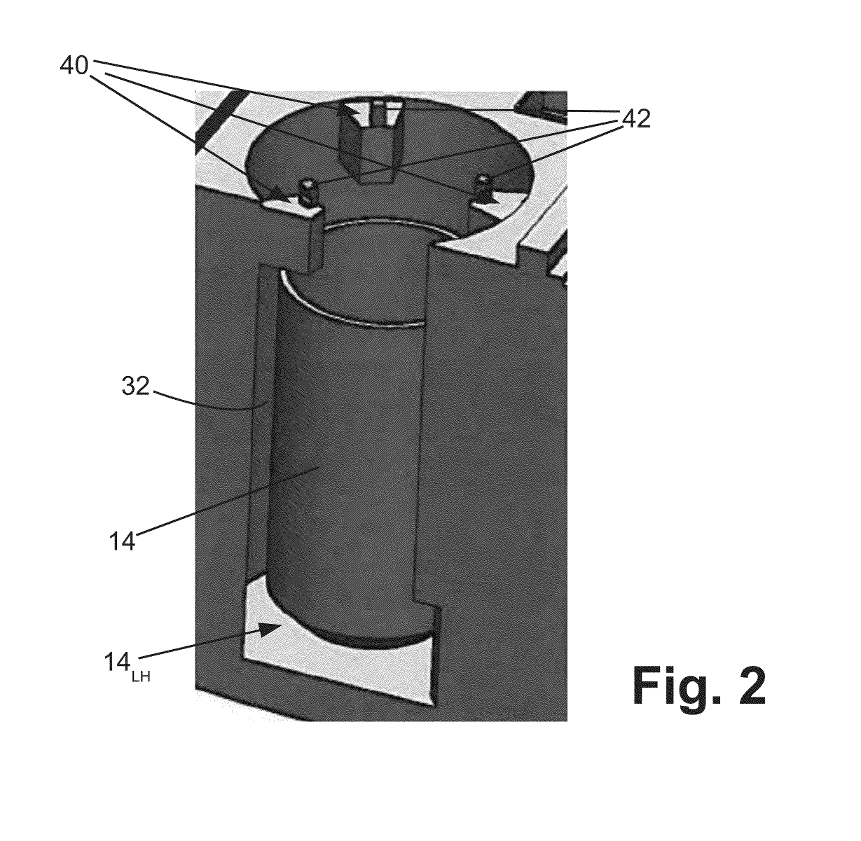

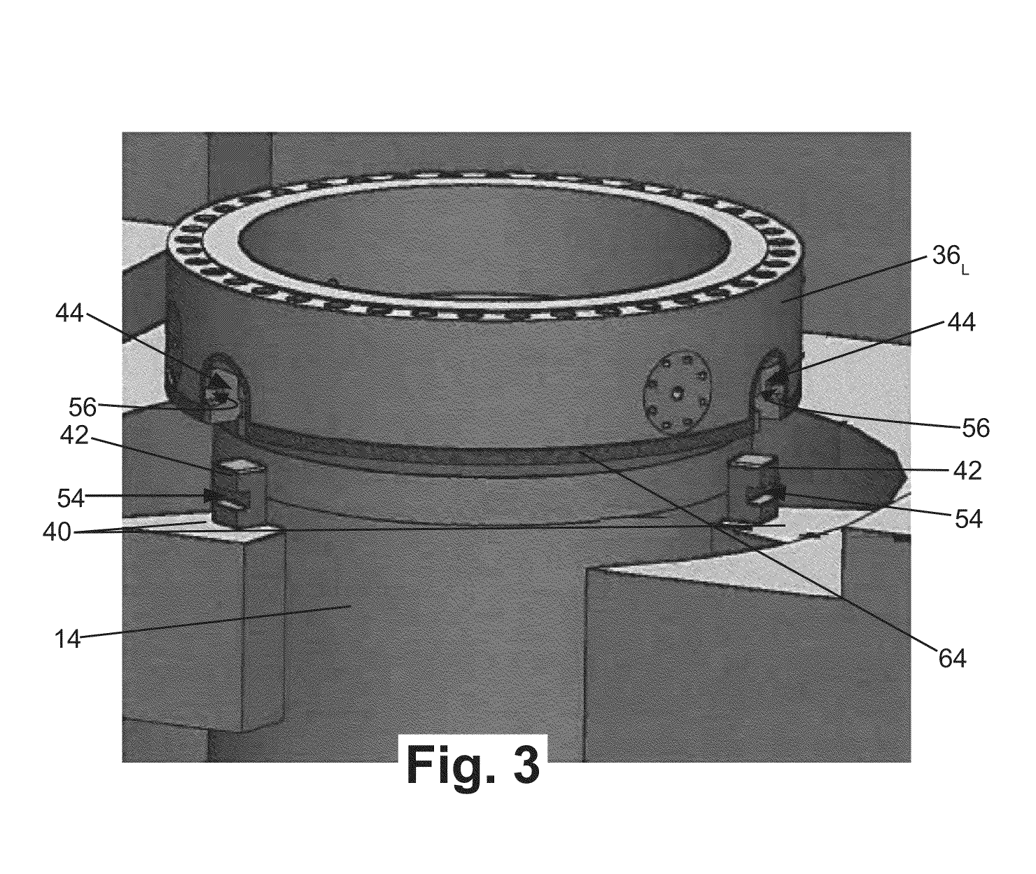

In the illustrative example of FIG. 1, and with further reference to FIGS. 2 and 3, the nuclear reactor (and more particularly the reactor pressure vessel 14) is supported in suspended fashion at or near a flange coupling 36 of the reactor pressure vessel 14 by a set of three support engagement surfaces 40 built into or otherwise anchored to the top of the reactor cavity 32 or otherwise anchored to the civil structure of the radiological containment 24. The illustrative flange coupling 36 is located at around the mid-elevation of the pressure vessel 14. In the illustrative integral PWR design, during refueling the reactor pressure vessel 14 is opened at the flange coupling 36 and the upper portion of the pressure vessel 14 including the steam generator(s) 16 is lifted off to provide access to the nuclear reactor core 12. This is merely an illustrative design, and in other contemplated embodiments the flange coupling 36 may be located elsewhere, for example near the top of the pressure vessel so that an upper vessel head may be removed via the flange coupling to perform the refueling.

Regardless of the flange coupling location, the nuclear reactor 10 is preferably supported in suspended fashion at an elevation located below the center-of-gravity 34 of the nuclear reactor 10. In the illustrative example this support is via the three support engagement surfaces 40, which are preferably evenly spaced at 120° intervals around the reactor pressure vessel 14. (Note that in FIGS. 1 and 3, only two of the support engagement surfaces 40 are visible, while in the perspective view from an elevated vantage point shown in FIG. 2 all three support engagement surfaces 40 are visible. The illustrative support engagement surfaces 40 are narrow ledges that extend inboard from the perimeter of the reactor cavity 32.

The use of specifically three spaced-apart support engagement surfaces 40 has certain advantages. With this arrangement, it is ensured that each of the three spaced-apart support engagement surfaces 40 carries load of the reactor weight. Two (relatively narrow) support engagement surfaces is insufficient because the two support surfaces would define a linear axis about which the reactor could rotate, which is especially likely when the center of gravity is above the support elevation. On the other hand, with four or more spaced apart support engagement surfaces, there is a possibility that the weight of the reactor could shift off of one or more of the support engagement surfaces so that the remaining support engagement surfaces carry additional load. This is acceptable, but requires that the four or more support engagement surfaces be “over-designed” to accommodate the additional load. Using specifically three support engagement surfaces 40 spaced apart at 120° intervals around the nuclear reactor 10, as illustrated, defines a minimum support configuration off of which the weight of the reactor cannot readily shift. While a single continuous, e.g. annular, support surface could alternatively be employed, this would effectively close the top of the reactor cavity, which would impede flooding of the cavity during a LOCA response, and would also complicate reactor access for maintenance operations.

FIG. 2 shows a portion of the civil structure in partial cutaway including the reactor cavity 32 and the three support engagement surfaces 40, along with a lowermost portion of the reactor pressure vessel 14 with the upper portion including the flange coupling 36 cut away. As seen in FIG. 2, the illustrative support engagement surfaces 40 each include a lug 42.

FIG. 3 shows an enlarged view in partial cutaway of the top of the reactor cavity 32 and the three support engagement surfaces 40, along with the lower portion of the reactor pressure vessel 14 including a lower vessel flange 36_{L} (which is part of the flange coupling 36). In illustrative FIG. 3 the lower portion of the reactor pressure vessel 14 is shown in a slightly elevated position, such as it might assume when being lowered into the reactor cavity 32 but before engaging the three support engagement surfaces 40. As seen in FIG. 3, lug cutouts 44 are located at the bottom outer region of the lower vessel flange 36_{L}. These lug cutouts 44 mate with the vertical lugs 42 located on the respective support engagement surfaces 40 of the civil structure of the radiological containment structure 24. When the lower portion of the reactor pressure vessel 14 is initially lowered into the containment, it is clocked (that is, arranged rotationally) so that the lug cutouts 44 in the lower vessel flange 36_{L} slide down over the vertical lugs 42 of the respective support engagement surfaces 40. The lugs 42 do not bear the weight of the reactor vessel 14, but rather serve as seismic restraints. The weight of the reactor pressure vessel 10 is borne by the support engagement surfaces 40, and more particularly in the illustrative embodiment by the lower edge of the lower vessel flanges 36_{L} resting on the upper surfaces of the support engagement surfaces 40. The lug cutouts 44 in the lower vessel flange 36_{L} are arranged in a circular pattern around the perimeter of the lower vessel flange 36_{L}, spaced apart by 120° intervals, and are used to transfer the lateral seismic loads from the lower vessel flange 36_{L} to the civil structure.

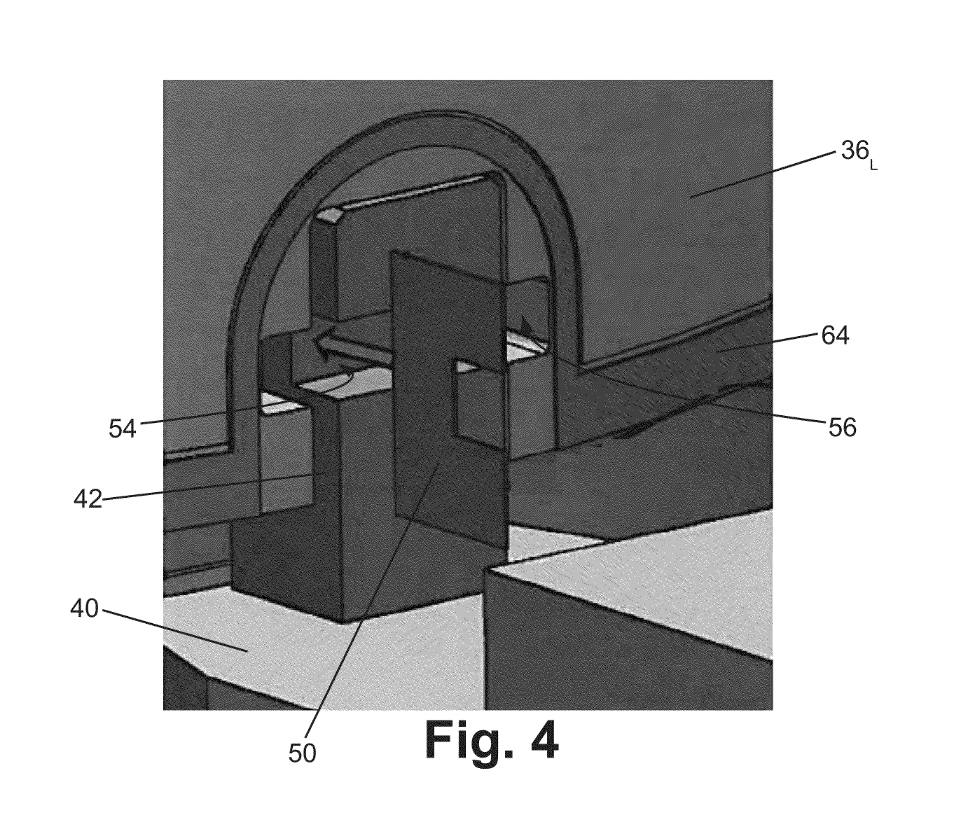

With reference to FIG. 4, the lugs 42 and lug cutouts 44 are preferably sized with gaps between the lateral edges to allow the reactor pressure vessel 14 to thermally grow radially and not contact the civil structure lugs 42. However, such gaps can adversely impact compliance with applicable nuclear regulations regarding seismic support. In some such regulations, a gap of 1/16-inch or less is required to allow for the seismic analysis to consider the interface between the two elements 42, 44 to be in direct contact. To achieve this, as shown in FIG. 4, the gaps are optionally closed (at least partially) by placing shims 50 into these gaps that reduce the gaps less than 1/16-inch (or another target gap size). The remaining gap of 1/16-inch or less allows for the reactor pressure vessel 14 to move to accommodate radial thermal expansion and contraction, or vessel rotation, without creating friction and wear points on the shims 50. The lugs 42 and mating lug cutouts 44 thus define a seismic rotational restraint assembly that allows the reactor pressure vessel 14 to thermally expand or contract radially, but prevents rotational of the pressure vessel 14 during a seismic event.

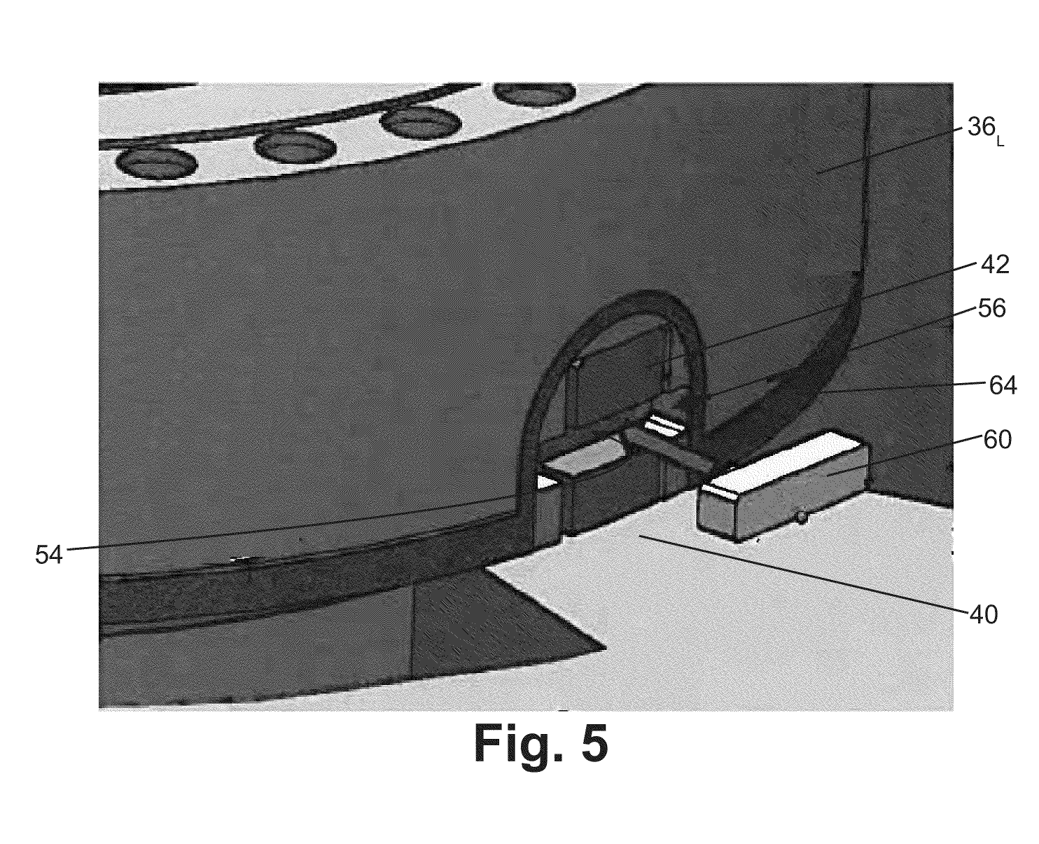

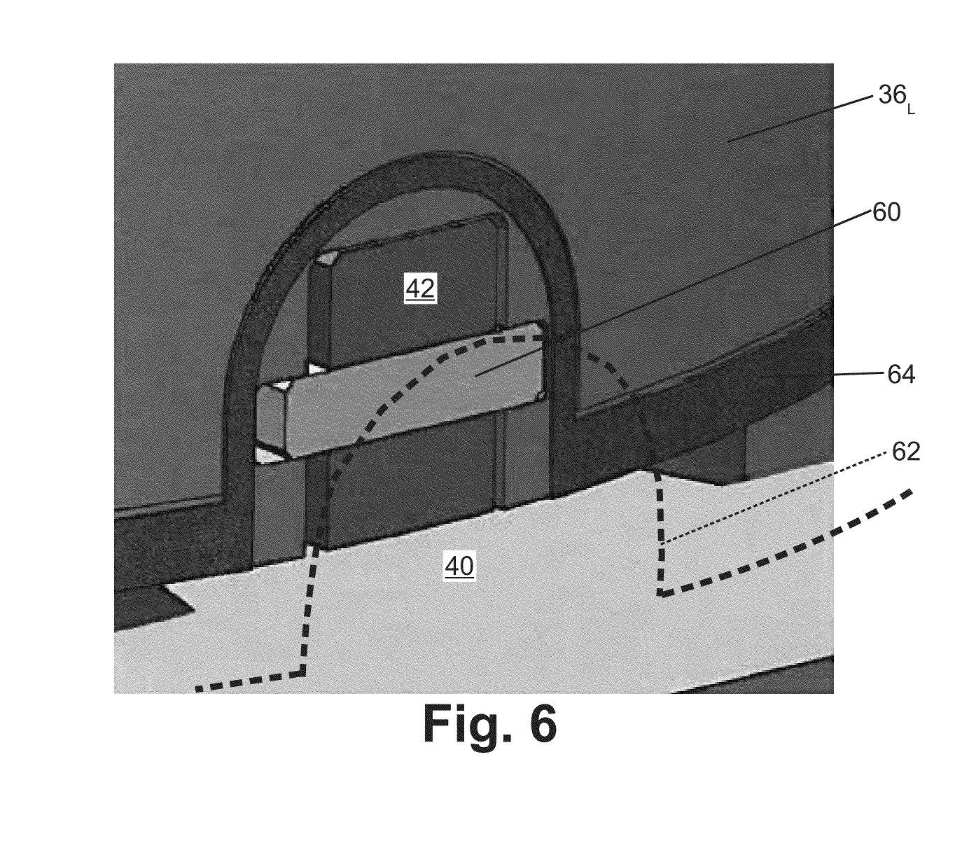

With reference to FIGS. 5 and 6, as previously mentioned the lugs 42 serve as seismic rotational restraints, and in the illustrative embodiment do not bear the weight of the reactor vessel 14. As seen in FIGS. 5 and 6, the weight of the reactor pressure vessel 10 is borne by the support engagement surfaces 40 as the lower edge of the lower vessel flange 36_{L} rests on the support engagement surfaces 40. To prevent vertical liftoff of the lower vessel flange 36_{L} from the support engagement surfaces 40 during a seismic event, the lugs 42 include slots 54 and the lug cutouts 44 include notches 56 aligned horizontally with the lug slots 54. At each support engagement surface 40, a locking block 60 is inserted into the lug slot 54 and extends laterally into the notches 56 in the lug cutout 44 so as to tie the lower vessel flange 36_{L} to the support engagement surface 40 via the lug 42. This prevents the lower vessel flange 36_{L} from vertically lifting off of the support engagement surfaces 40 during a seismic event. In this block-in-slots-and-notches arrangement, suitable gaps are provided to accommodate radial displacement due to thermal expansion of the lower vessel flange 36_{L}. Various approaches can be employed to ensure that the shims 50 and locking blocks 60 stay in position. In one approach, which is diagrammatically indicated in FIG. 6, a seal plate 62 (shown in phantom in FIG. 6) is welded to the periphery of the lower vessel flange 36_{L}. FIGS. 3-6 show weld buttering 64 on the lower vessel flange 36_{L} to facilitate this welding. Thus, the lugs 42 and mating lug cutouts 44, together with the locking blocks 60, define a vertical liftoff prevention assembly that prevents the lower vessel flange 36_{L} from lifting off the support engagement surfaces 40 during a seismic event.

With returning reference to FIG. 1, the center-of-gravity 34 of the nuclear reactor 10 is located above the plane of the support engagement surfaces 40. As a result, a moment may occur when the nuclear reactor 10 undergoes a seismic event, in that the lateral seismic loading of the nuclear reactor 10 may urge a pendulum motion on the upper and lower regions of the nuclear reactor 10 about the plane of the support engagement surfaces 40.

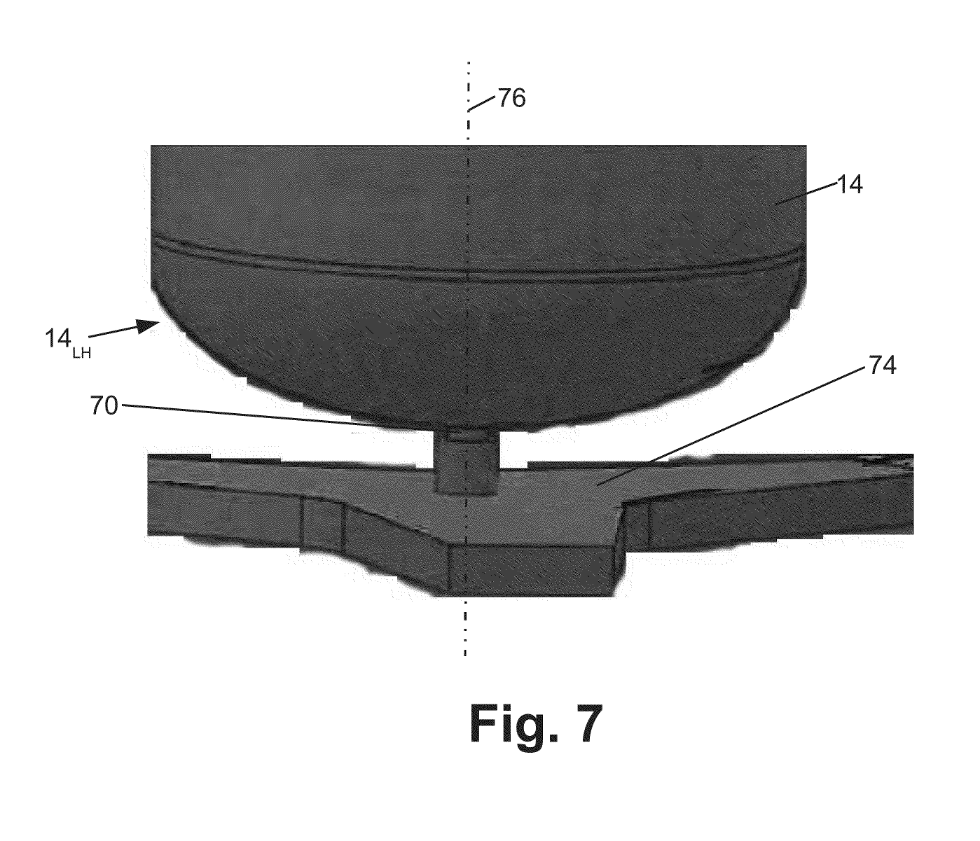

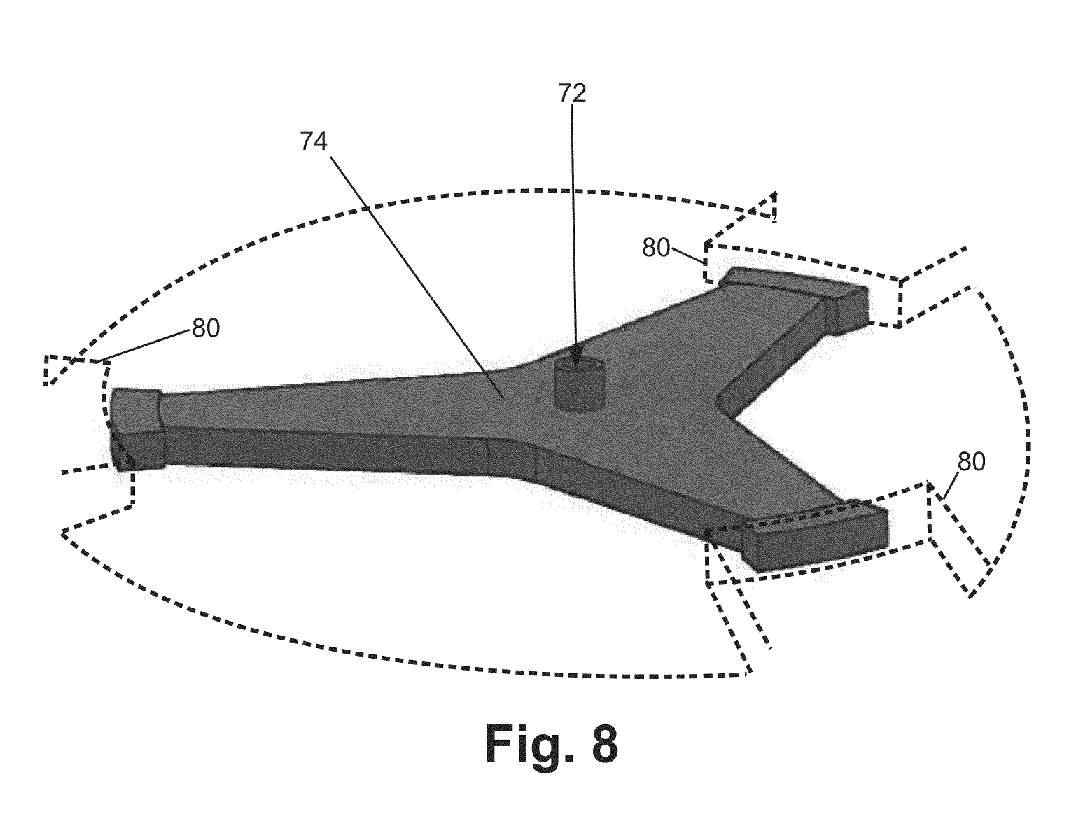

With continuing reference to FIG. 1 and with further reference to FIGS. 7 and 8, to prevent seismically induced pendulum motion of the reactor pressure vessel 10, a bottom seismic support is provided. In the illustrative embodiment, the bottom seismic support comprises a pin 70 that is connected to the bottom of the reactor pressure vessel 14 (specifically on the lower extremum, that is, bottom, of the lower vessel head 14_{LH} of the reactor pressure vessel 14) and that extends downward and fits into a female pin socket 72 (see FIG. 8) of a support base 74 located at the bottom of the reactor cavity 32, that is, on or in the floor of the civil structure located beneath the nuclear reactor 10. The pin 70 preferably has the shape of a circular cylinder (optionally including a rounded or tapered tip, broadened region at the upper end where it connects with the reactor pressure vessel 14, or so forth). The pin socket 72 of the support base 74 is sized and shaped to receive the pin 70 with lateral tolerances small enough to provide the design-basis lateral seismic restraint. The pin 70 is oriented vertically and is coaxial with the vertical axis of the reactor pressure vessel 14. Said another way, an axis 76 labeled in FIGS. 1 and 7 is both the cylinder axis of the circular cylindrical pin 70 and the vertical axis passing through the center of gravity 34 of the nuclear reactor 10. Said yet another way, the pin 70 defines a pin axis that is coaxial with a cylinder axis of the cylindrical main body of the reactor pressure vessel 14. The pin 70 is located on the centerline of the reactor pressure vessel 14 so that as the vessel 14 thermally grows downward as the reactor 10 heats up as it is brought into operation, the pin 70 moves only vertically downward and stays within the mating pin socket 72. The pin socket 72 should be deep enough that the lower end of the pin 70 does not contact the bottom of the opening of the pin socket 72 for any credible temperature/extent of thermal expansion. The circular pin 70 is located on the reactor axis 76 and is preferably small relative to the diameter of the reactor pressure vessel 14—as a result, radial thermal growth of the pin 70 is minimized. To restrain lateral movement during a seismic event, the circular pin 70 contacts the sidewall of the support base 74 so as to eliminate pendulum motion of the nuclear reactor 10 during a seismic event.

The pin 70 on the bottom of the lower vessel head 14_{LH} of the reactor pressure vessel 14 may be fabricated in various ways. In one approach, the pin 70 is a separate element (e.g. forged, cast, machined from square stock, or cut from round steel stock) that is welded to the bottom of the lower vessel head 14_{LH} of the reactor pressure vessel 14. In another approach, the pin 70 is fabricated integrally with the lower section of the reactor pressure vessel 14, for example being forged together with the rest of the lower vessel head 14_{LH} as a single unitary forging.

The lateral seismic load is transferred from the nuclear reactor 10 to the pin 70 and to the support base 74 which is secured to the civil structure (the floor of the reactor cavity 32 in illustrative FIG. 1). In some contemplated embodiments (not shown), the support base is the floor of the reactor cavity 32 (or other radiological containment floor located underneath the reactor), and the pin socket 72 is suitably a hole drilled into that concrete floor, optionally reinforced by an cylindrical collar of steel or another suitable material (which may optionally extend a distance above the floor). However, this approach has the disadvantage that the hole drilled into the concrete floor can present a pathway for corium ingress into the concrete in the event of an ex vessel core retention event. The opening in such a design is also susceptible to buildup of contaminants that may collect on the floor of the reactor cavity 32, although this can be reduced by employing a steel collar extending above the floor.

With continuing reference to FIGS. 7 and 8, in the illustrative example the support base 74 is separate from the floor of the reactor cavity 32 (or other radiological containment floor located underneath the nuclear reactor) and rests on that floor. The illustrative support base 74 includes three horizontal legs extending away from the pin socket 72, spaced apart circumferentially at 120° intervals around the pin socket 72. Three legs is the minimum needed to provide lateral seismic restraint in any lateral direction; four or more legs are also contemplated. Alternatively the support base may be of another geometry, such as a circular base or a square base.

With particular reference to FIG. 8, lateral motion of the support base 74 on this floor is prevented by suitable abutment elements 80 (shown in phantom in FIG. 8) which are secured to the floor of the reactor cavity 32 (or other radiological containment floor located underneath the nuclear reactor). The abutment elements 80 may, for example, be concrete structures deposited and set on top of the concrete floor, preferably with steel faces engaging the support base. In another embodiment, the abutment elements 80 are a steel structure whose outer circumference coincides with the circumference of the floor of the reactor cavity 32, so that the lateral seismic load is transferred via the abutment elements 80 to the bottom of the sidewall of the reactor cavity 32. Other configurations for integrating or securing the pin socket 72 to the floor of the reactor cavity 32 (or other radiological containment floor located underneath the nuclear reactor) are also contemplated.

Under some nuclear regulatory jurisdictions and in accordance with industry practice, a gap of 1/16-inch or less between the pin 70 and the inner diameter (ID) of the pin socket 72 allows the seismic analysis to consider the interface between the two elements 70, 72 as being in direct contact. Because the radial thermal expansion of the (preferably small-diameter) pin 70 is small, this tolerance is expected to be readily achieved in most designs without the use of shimming. The lateral seismic load that results from the pendulum effect operating on the nuclear reactor 10 is distributed from the pin 70 to the pin socket 72 in the center of the support base 74, to the ends of the legs of the support base 74, to the abutments 80 (or to the walls of the reactor cavity 32 if the base is a plate of diameter commensurate with the reactor cavity diameter, or so forth). The support base 74 is suitably constructed of plate steel or the like of sufficient thickness, and with the legs of sufficient lateral width, to prevent buckling under the lateral loading generated by seismic pendulum movement of the nuclear reactor 10. In view of thermal considerations, it is contemplated for the support base 74 to be supported on the floor of the reactor cavity 32 by footers or the like, so as to define an air gap between the support base 74 and the floor to allow for circulation of the heating ventilating and air conditioning (HVAC) around the support base 74.

It will be appreciated that the bottom seismic support comprising the pin 70 and support base 74 with the mating pin socket 72 advantageously has minimal contact with the bottom of the reactor pressure vessel 14. Thus, the bottom seismic support does not restrict water flooding the reactor cavity 32 during a LOCA response (or other unscheduled reactor shutdown scenario) from contacting and immersing the lower portion of the reactor pressure vessel 14 in order to provide core cooling.

While the pin 70 and pin socket 72 assembly is expected to provide effective restraint against pendulum motion of the reactor during a seismic event, other restraints for this purpose are also contemplated.

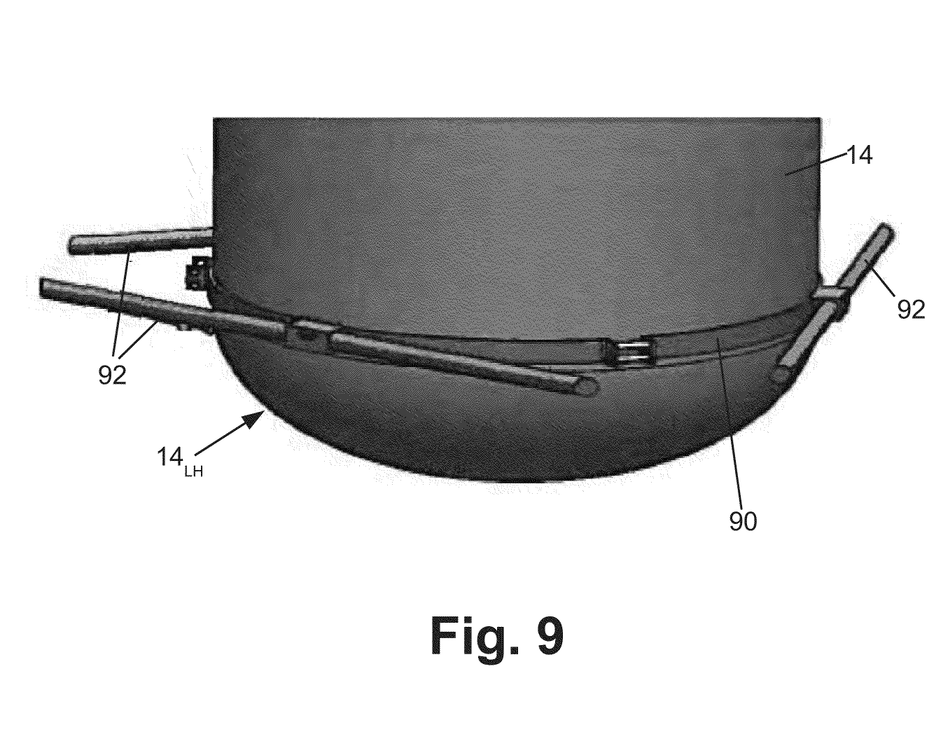

With reference to FIG. 9, in one alternative approach a tension band 90 is placed around the lower portion of the reactor pressure vessel 14, and horizontal rods 92 attach to the tension band 90. The ends of the horizontal rods 92 may suitably be anchored to the wall of the reactor cavity 32 (not shown). The mechanical properties of the rods 92 (controlled by the material and rod diameter) are chosen to allow the rods 92 to bow from the thermal expansion and provide lateral restraint.

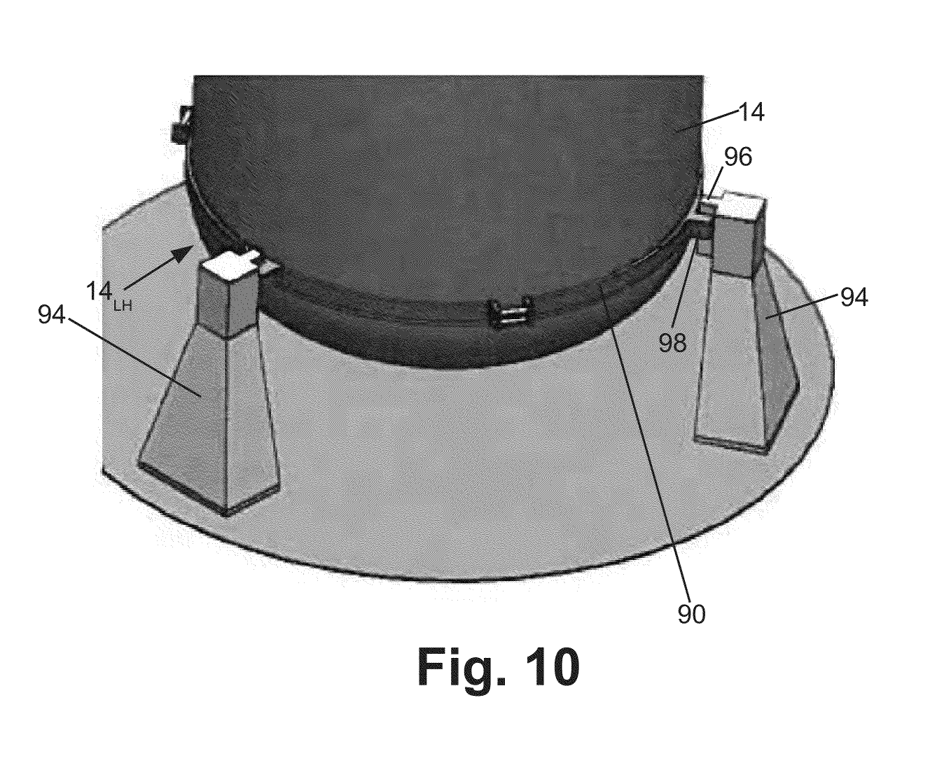

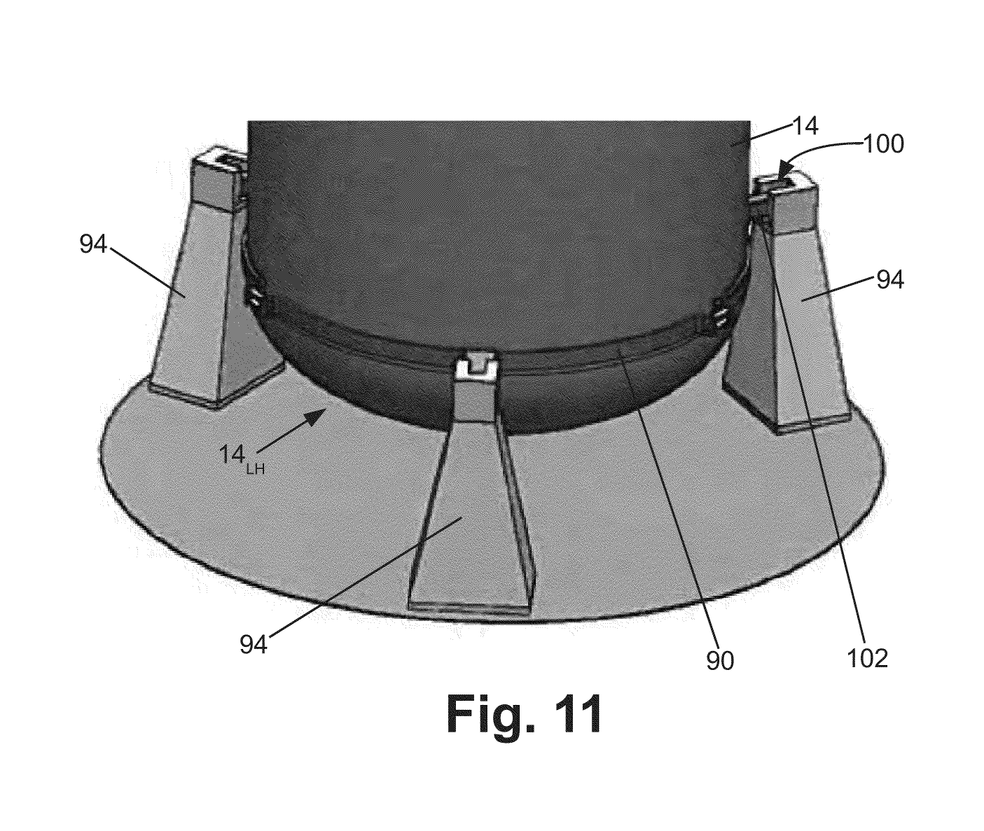

With reference to FIGS. 10 and 11, in an alternative embodiment the tension band 90 is restrained by restraint posts 94 that are anchored to the floor of the reactor cavity 32. In the embodiment of FIG. 10, the restraint posts 94 include vertical elements 96 that engage vertical slots 98 extending from the tension band 90. In the embodiment of FIG. 11, the restraint posts 94 include vertical slots 100 that engage vertical elements 102 extending from the tension band 90. The male/female vertical slot/element interface allows for vertical thermal expansion of the reactor pressure vessel 14. During a lateral seismic event the load is routed through the male/female slot/element interface to the restraint posts 94 and thence to the floor of the reactor cavity 32 (or other civil structure on which the restraint posts 94 are anchored).

In general, the embodiments of the restraint against pendulum motion of the reactor described with reference to FIGS. 9-11 utilize at least three points of lateral contact to restrain the reactor from pendulum motion in any direction. Three points of lateral contact spaced apart by 120° is sufficient to restrain pendulum motion in any direction. By contrast, two points of lateral contact would be insufficient.

The illustrative seismic restraints compensate for both lateral and vertical seismic loads, while accommodating thermal expansion. The seismic restraint system employs a two-point seismic restraint configuration, in which primary support is provided by the support engagement surfaces 40 and lateral pendulum motion suppression is provided by the pin 70 and mating pin socket 72 along with the support base 74.

The primary vertical bearing support of the nuclear reactor 10 is provided by the bottom surface of the lower vessel flange 36_{L} resting on the support engagement surfaces 40 of the civil structure in the radiological containment. In other contemplated embodiments, the three (relatively narrow) bearing surfaces 40 could be extended to four or more such surfaces, preferably spaced at equal angular intervals around the nuclear reactor (for example, four such surfaces spaced at 90° intervals around the nuclear reactor, five such surfaces spaced at 72° intervals around the nuclear reactor, or so forth), or could be further extended and joined together to form a single annular support surface encompassing the entire lower surface of the lower vessel flange 36_{L} (although this latter design would likely entail adding vent openings and/or other access to the reactor cavity 32 to allow it to be flooded and steam vented). Moreover, the vertical support bearings 40 can support a feature of the pressure vessel other than the illustrative lower vessel flange 36_{L}. For example, in a vessel design employing a removable upper vessel head for refueling, in which the flange coupling for opening the vessel is near the top of the pressure vessel (e.g. a flange coupling via which the removable upper vessel head is attached), suitable primary support may be provided via a ledge formed by a suitable narrowed or constricted diameter portion of the pressure vessel, or may be provided by including protrusions extending from around the middle of the reactor pressure vessel. In embodiments employing protrusions, such protrusions may be integrally included as part of the vessel forging, or welded to the vessel, or attached using a tension band, or so forth.

Liftoff during seismic events is suppressed by the lugs 42 and engaging locking block 60, which allows for construction and installation without exceeding precise location requirements on the interfacing civil structure. Other liftoff prevention configurations are also contemplated. For example, in an alternative embodiment in which the primary support is via protrusions extending from around the middle of the reactor pressure vessel, such protrusions may include slots and the liftoff prevention mechanism is suitably a bolt passing through the slot and threading into a tapped hole in the support engagement surface 40 (or into a bolt located below a through-hole passing through the support engagement surface in a variant embodiment). In this approach, the bolt head is sized to be too large to pass through the slot, and the bolt is tightened down such that the gap between the top of the protrusion and the bottom of the bolt head is within the required tolerance for seismic restraint. Radial thermal expansion of the reactor pressure vessel can be accommodated in such a design by orienting the slot along the radial direction. The bolt also serves as a seismic rotational restraint assembly due to the engagement between the bolt and the slot preventing rotation of the pressure vessel.

At the lower point of the two-point seismic restraint configuration, the illustrative pin 70 and pin socket 72 is optionally replaced by another lateral seismic restraint configuration, such as one of those described herein with reference to FIGS. 9-11. As another contemplated variant, the male and female aspects of the illustrative pin 70 and pin socket 72 assembly may be reversed—that is, a pin may be anchored to the floor of the reactor cavity (or other floor of the civil structure located beneath the nuclear reactor) and a pin socket may be formed as a hole in the bottom of the reactor pressure vessel lower head.

While illustrative embodiments have been described herein, it is to be appreciated that more generally the seismic restraint for the nuclear reactor 10 includes (i) a primary support on which the nuclear reactor is supported (for example, the support engagement surfaces 40), the primary support anchored to a civil structure of a radiological containment containing the nuclear reactor (anchored to the reactor cavity 32 of the radiological containment 24 in the illustrative examples) and defining a reactor support plane (the plane of the support engagement surfaces 40 in the illustrative examples) located above the bottom of the nuclear reactor 10 and below the center of gravity 34 of the nuclear reactor and (ii) a lateral seismic support engaging the nuclear reactor at a plane or point located below the reactor support plane (for example, the pin 70 and associated features 72, 74, or the alternative lateral seismic support embodiments described with reference to FIGS. 9-11), the lateral seismic support configured to prevent pendulum motion of the nuclear reactor.

Illustrative embodiments including the preferred embodiments have been described. While specific embodiments have been shown and described in detail to illustrate the application and principles of the invention and methods, it will be understood that it is not intended that the present invention be limited thereto and that the invention may be embodied otherwise without departing from such principles. In some embodiments of the invention, certain features of the invention may sometimes be used to advantage without a corresponding use of the other features. Accordingly, all such changes and embodiments properly fall within the scope of the following claims. Obviously, modifications and alterations will occur to others upon reading and understanding the preceding detailed description. It is intended that the present disclosure be construed as including all such modifications and alterations insofar as they come within the scope of the appended claims or the equivalents thereof.

We claim:

1. A nuclear island comprising:
a nuclear reactor including a nuclear reactor core comprising fissile material disposed in a reactor pressure vessel;
a primary support by which the nuclear reactor is supported, the primary support anchored to a civil structure of a radiological containment containing the nuclear reactor and defining a reactor support plane located above the bottom of the nuclear reactor and below the center of gravity of the nuclear reactor; and
a lateral seismic support engaging the nuclear reactor at a plane or point located below the reactor support plane, the lateral seismic support configured to prevent lateral motion of the nuclear reactor.

2. The nuclear island of claim 1 wherein the primary support comprises:
a support engagement surface anchored to the civil structure of the radiological containment containing the nuclear reactor,
wherein a flange, protrusion, or ledge of the reactor pressure vessel rests on the support engagement surface, the flange, protrusion, or ledge being located above the bottom of the nuclear reactor and below the center of gravity of the nuclear reactor.

3. The nuclear island of claim 2 wherein the support engagement surface comprises a plurality of support engagement surfaces spaced at equal angular intervals around the nuclear reactor.

4. The nuclear island of claim 3 wherein the support engagement surface comprises three support engagement surfaces spaced at equal angular intervals of 120° around the nuclear reactor.

5. The nuclear island of claim 2 wherein the primary support further comprises a seismic rotational restraint assembly configured to prevent the nuclear reactor from rotating during a seismic event.

6. The nuclear island of claim 5 wherein the seismic rotational restraint assembly comprises:
a plurality of lugs disposed on the support engagement surface; and
lug cutouts defined in the flange, protrusion, or ledge of the reactor pressure vessel, the lugs being mated into the lug cutouts.

7. The nuclear island of claim 6 further comprising:
locking blocks, wherein a locking block is inserted into a lug slot of each lug and extends laterally into notches in the mating lug cutout so as to tie the flange, protrusion, or ledge of the reactor pressure vessel to the support engagement surface via the lug.

8. The nuclear island of claim 2 wherein the primary support further comprises a liftoff prevention assembly configured to prevent vertical liftoff of the flange, protrusion, or ledge of the reactor pressure vessel from the support engagement surface on which the flange, protrusion, or ledge rests.

9. The nuclear island of claim 8 wherein the liftoff prevention assembly comprises:
a plurality of lugs; and
lug cutouts defined in the flange, protrusion, or ledge of the reactor pressure vessel, the lug cutouts configured to lock with the lugs.

10. The nuclear island of claim 2 wherein the radiological containment containing the nuclear reactor includes a reactor cavity inside of which is disposed a lower portion of the nuclear reactor including the nuclear reactor core, and wherein the support engagement surface is anchored to the top of the reactor cavity.

11. The nuclear island of claim 1 wherein the lateral seismic support comprises:
a pin connected with one of (i) the bottom of the reactor pressure vessel and (ii) a floor of the civil structure of the radiological containment containing the nuclear reactor; and
a pin socket comprising an opening configured to receive the pin, the pin socket being connected with or formed in the other of (i) the bottom of the reactor pressure vessel and (ii) a floor of the civil structure of the radiological containment containing the nuclear reactor.

12. The nuclear island of claim 11 wherein the lateral seismic support comprises:
said pin connected with the bottom of the reactor pressure vessel; and
said pin socket connected with or formed in the floor of the civil structure of the radiological containment containing the nuclear reactor.

13. The nuclear island of claim 12 wherein the lateral seismic support further comprises:
a support base connected to the pin socket and disposed on the floor of the civil structure of the radiological containment containing the nuclear reactor.

14. The nuclear island of claim 11 wherein the pin comprises a circular cylindrical pin having its cylinder axis coaxial with a vertical axis that passes through the center of gravity of the nuclear reactor.

15. The nuclear island of claim 11 wherein the pin comprises a circular cylindrical pin oriented vertically and coaxial with the vertical axis of the reactor pressure vessel.

16. The nuclear island of claim 1 wherein the lateral seismic support comprises:
three restraints engaging the nuclear reactor at said plane located below the reactor support plane, the three restraints engaging the nuclear reactor at point spaced apart by 120° intervals around the nuclear reactor.

17. An apparatus comprising:
a reactor pressure vessel including a cylindrical main body, an upper vessel head closing the top of the cylindrical main body, and a lower vessel head closing the bottom of the cylindrical main body; and
a pin connected to the bottom of the lower vessel head.

18. The apparatus of claim 17 wherein the pin is a circular cylindrical pin.

19. The apparatus of claim 18 wherein the circular cylindrical pin has a cylinder axis that is coaxial with a cylinder axis of the cylindrical main body of the reactor pressure vessel.

20. The apparatus of claim 17 wherein the pin and the lower vessel head comprise a single forging.

21. The apparatus of claim 17 wherein the pin defines a pin axis that is coaxial with a cylinder axis of the cylindrical main body of the reactor pressure vessel.

22. The apparatus of claim 17 further comprising:
a nuclear reactor core comprising fissile material disposed in the reactor pressure vessel closer to the lower vessel head than to the upper vessel head.

23. The apparatus of claim 22 further comprising:
a radiological containment that contains a nuclear reactor comprising the reactor pressure vessel, the nuclear reactor core disposed in the reactor pressure vessel, and the pin connected to the bottom of the lower vessel head; and
a pin socket disposed on or in a floor of the radiological containment underneath the nuclear reactor with the pin mated into the pin socket.

24. The apparatus of claim 23 further comprising:
a support base connected to the pin socket and disposed on the floor of the radiological containment.

25. A method operating in conjunction with a nuclear reactor that includes a nuclear reactor core comprising fissile material disposed in a reactor pressure vessel and further operating in conjunction with a civil structure of a radiological containment that contains the nuclear reactor, the method comprising:
suspending the nuclear reactor at a reactor support plane passing through the nuclear reactor wherein the reactor support plane is below a center of gravity of the nuclear reactor; and
restraining the nuclear reactor against lateral motion at a plane or point located below the reactor support plane.

26. The method of claim 25 wherein the restraining comprises:
restraining the nuclear reactor at point at the bottom of a lower vessel head of the nuclear reactor.

27. The method of claim 25 wherein the suspending comprises:
resting a flange, protrusion, or ledge of the reactor pressure vessel located at the reactor support plane on a support engagement surface.

28. The method of claim 27 further comprising:
restraining the flange, protrusion, or ledge of the reactor pressure vessel from lifting off of the support engagement surface.

29. The method of claim 27 further comprising:
restraining the flange, protrusion, or ledge of the reactor pressure vessel from rotation using a seismic rotational restraint assembly disposed with the support engagement surface.
